(19) United States
(12) Patent Application Publication
(10) Pub. No.: US 2007/0179634 A1
(43) Pub. Date: Aug. 2, 2007

(54) Method of controlling a process

(75) Inventor: Chunsheng Fu, West Chester, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(73) Assignee: The Procter & Gamble Company

(21) Appl. No.: 11/342,086

(22) Filed: Jan. 27, 2006

(51) Int. Cl. G05B 11/01

(52) U.S. Cl. 700/17

(57) ABSTRACT

A method controls the execution of a process. The method includes the steps of providing a first controller adapted to receive inputs and to control outputs based upon a predetermined relationship between inputs and outputs, defining the process as a batch recipe comprising a collection of tasks, defining at least one task in terms of subtasks, and subtasks I terms of conditions according to the formulae:

$$Task ( i ) = {{⋃}_{j = 1}}^{{N}_{i}} G ( i , j ) = G ( i , 1 ) ⋃ G ( i , 2 ) ⋃ G ( i , 3 ) … ⋃ G ( i , {N}_{i} )$$

$$G ( i , j ) = {{⋂}^{{M}_{ij}}}_{k = 1} C ( i , j , k ) = C ( i , j , 1 ) ⋂ C ( i , j , 2 ) ⋂ C ( i , j , 3 ) … ⋂ C ( i , j , {M}_{ij} )$$

wherein, “∩” represents an “AND” relationship and “∪” represents an “OR” relationship,

### FIELD OF THE INVENTION

The present invention relates to methods for the control of process applications using condition driven task management. The invention relates particularly to methods for the control of batch processes using condition driven task management.

### BACKGROUND OF THE INVENTION

Process control is a well developed art. Process control in general and batch process control in particular are each well known. One method for controlling a batch process begins with the delineation of the batch process into steps set forth in a sequence function chart for the process.

The use of process controllers is also well known. The steps set forth in the sequence function chart may be programmed into the memory of a process controller used to control and/or monitor a particular batch process. The steps may then be executed to carry out the steps of a particular batch recipe. Altering the steps of such a programmed recipe requires altering the coded programming of the process controller, or of a recipe server that has been adapted to serve programmed recipes to the process controller.

Reprogramming a process controller or recipe server may tend to limit the flexibility of the control system and to prevent process operators from interacting with the process control recipe to accommodate real time issues in a particular batch execution.

A control system allowing the process operator greater flexibility in altering the batch recipe in response to real time process conditions and to accommodate trends and singularities in ingredient quality and equipment performance, among other variables, is desired.

### SUMMARY OF THE INVENTION

A method controls a process. The method includes the step of providing a first controller. The first controller's configuration enables it to receive inputs and to control outputs based upon a predetermined relationship between those inputs and outputs. The method also includes defining the process as a recipe which in turn comprises a collection of tasks. At least one task of the recipe is defined in terms of subtasks which are defined in terms of conditions. The following formulae express the relationship between the at least one task, its subtasks and the conditions of the subtasks:

$$Task ( i ) = {{⋃}_{j = 1}}^{{N}_{i}} G ( i , j ) = G ( i , 1 ) ⋃ G ( i , 2 ) ⋃ G ( i , 3 ) … ⋃ G ( i , {N}_{i} )$$

$$G ( i , j ) = {{⋂}^{{M}_{ij}}}_{k = 1} C ( i , j , k ) = C ( i , j , 1 ) ⋂ C ( i , j , 2 ) ⋂ C ( i , j , 3 ) … ⋂ C ( i , j , {M}_{ij} )$$

Task(i) represents the ith task of the recipe, G(i,j) represents the jth subtask of Task(i), C(i,j,k) represents the kth condition of the G(i,j) subtask, “∩” represents an “AND” relationship and “∪” represents an “OR” relationship. The method associates at least one condition C(i,j,k) with a real or virtual input of the controller. The method alters the value of at least one real or virtual output when all of the conditions C(i,j,k) of at least one subtask G(i,j) of the at least one task Task(i) are satisfied.

In another aspect, the method controls a process apparatus. In this aspect a process control recipe comprised of tasks defines a process. The intersection of a plurality of subtasks defines at least one task. The union of a plurality of conditions defines at least one subtask. A provided controller has discrete input and output addresses associated with elements of the process apparatus. The method associates at least one condition with an input or output address of the provided controller and at least one task with a particular output address of the controller. The method alters the value of the particular output address associated with the task when the status of the task changes.

### DETAILED DESCRIPTION OF THE INVENTION

Throughout this description of the invention, exemplary forms of various elements related to or comprising the invention are provided. The These exemplary forms will be understood by one of skill in the art to serve as examples of the described elements and not to serve as defining limits to either the particular elements or the invention as a whole.

In one embodiment of the invention, a method controls a process. The process may be a batch or continuous process. Exemplary batch processes include mixing, brewing, baking and other cooking processes. Exemplary continuous processes to which the method has applicability include steel making, glass making, paper and other web material manufacturing.

The method includes the step of providing a first controller. The first controller may be any process controller including programmable logic controllers and distributed controllers, personal computer based controllers and other controllers as are known in the art. As a specific example, a ControlLogix Logix5563 available from Rockwell Automation, of Milwaukee, Wis.\may be provided as the first controller.

The first controller's configuration enables it to receive input data and to control output values based upon a predetermined relationship between input addresses and output addresses. Receiving input data and controlling output values relate to the receipt and generation of electrical, optical, or other signals. The input and output addresses may be related to actual or virtual input and output elements. Exemplary input sources include sensors providing particular information regarding apparatus element positions, process temperatures, weights, volumes and other parameters. Exemplary outputs include valve actuators, motor starters, solenoids, annunciators, indicator lights, as well as internal virtual outputs including timers, counters, holding registers and other known virtual outputs. Inputs and outputs may be analog or digital in nature, local or remote in location with respect to the physical location of the controller. The provided controller may be a part of a network of controller as is known in the art. Providing a network of controller may provide the capacity to incorporate additional processes and additional apparatus into a particular process recipe execution. A network of controllers may additionally facilitate interfacing with a particular controller and particular recipes from a plurality of locations both local to and remote from any particular controller.

The method also includes defining the process as a recipe. The recipe comprises a collection of tasks. At least one task of the recipe is defined in terms of subtasks which are defined in terms of conditions. The following formulae express the relationship between the at least one task, its subtasks and the conditions of the subtasks:

$$Task ( i ) = {{⋃}_{j = 1}}^{{N}_{i}} G ( i , j ) = G ( i , 1 ) ⋃ G ( i , 2 ) ⋃ G ( i , 3 ) … ⋃ G ( i , {N}_{i} )$$

$$G ( i , j ) = {{⋂}^{{M}_{ij}}}_{k = 1} C ( i , j , k ) = C ( i , j , 1 ) ⋂ C ( i , j , 2 ) ⋂ C ( i , j , 3 ) … ⋂ C ( i , j , {M}_{ij} )$$

Task(i) represents the ith task of the recipe. Anywhere from a single task of the recipe up to all tasks of the recipe may be so defined. G(i,j) represents the jth subtask of Task(i), and “∩” represents an “AND” relationship. C(i,j,k) represents the kth condition of the G(i,j) subtask, and “∪” represents an “OR” relationship. According to the formulae, the jth subtask G(i,j) of the ith task is satisfied when any condition C(i,j,k) is logically true. Also, the ith task is satisfied when all of the G(i,j) subtasks are logically true. The method associates at least one condition C(i,j,k) with a real or virtual input of the controller. The method alters the value of at least one real or virtual output when all of the conditions C(i,j,k) of at least one subtask G(i,j) of the at least one task Task(i) are satisfied.

In another embodiment, the method controls a process apparatus. In this embodiment a process control recipe comprised of tasks defines a process performed using the apparatus to perform at least a portion of the process. The intersection of a plurality of subtasks defines at least one task. The union of a plurality of conditions defines at least one subtask. A provided controller has discrete input and output addresses associated with elements of the process apparatus. The method associates at least one condition with an input or output address of the provided controller and at least one task with a particular output address of the controller. The method alters the value of the particular output address associated with the task when the status of the task changes.

In any embodiment, the formulae defining the process recipe may be stored in a memory portion of the process controller as is known in the art.

The configuration of the process control hardware may include an operator interface that enables a process operator to interface with the first controller. An exemplary interface comprises abilities to observe the progression of an execution cycle of the recipe, to monitor the values and/or status of input and output addresses, a graphic or textual display of process parameters, process flow and an overview of the process itself. An interface may allow the current configuration of a process recipe to be viewed by process operations personnel or others as desired.

The hardware of an interface may comprise hardware in a spectrum ranging from a simple grouping of indicator lights and switches up to and including a dedicated human machine interface computer including a graphical touch screen input display.

In one embodiment, the interface provides the ability for a process operator to alter the definition of at least one task in terms of subtasks as described above. In this embodiment, the process operator may choose to redefine the process recipe task due to changes in process apparatus performance, variations in the quality or quantity of incoming process ingredients or for other reasons to accommodate real time process issues or to alter the process output due to a change in the desired process output. In an embodiment having such an interface, the process operator, or others with access to the interface, may alter a task definition.

In one scenario, a process operator may view the current configuration of the process recipe and decide to alter a task definition to alter either an intermediate or ultimate result of the process. In this embodiment, the operator may also alter the displayed process recipe configuration in accordance with the changes made to the task definition.

In any embodiment, a first task may serve as a condition or subtask of a second task. That is, the performance and satisfaction of tasks may be nested such that a second task will be completed only upon the completion of a first task.

In one embodiment possible tasks are programmed into the memory of the control processor. The relationships between the respective tasks, the sequencing of the tasks and the control parameters of the tasks are not programmed with specificity.

A recipe is created using software accessed via an interface controller. The software allows the recipe to be expressed according to the formulae above. The recipe expresses the relationship between the equipment necessary to complete the batch, the sequence of operations necessary to complete the batch and the operating parameters associated with the batch process. Operating parameters may include, without being limiting, process temperatures, tank volume levels, cycle times, flow rates, motor speeds, and combinations of these.

The created recipe is given a name to facilitate specifying the recipe for use at a later time. The named recipe is then stored in the memory of the interface controller, in the process controller, or in a separate storage system.

At a time when there is a need or desire to use a particular recipe, the recipe is identified using the interface and is then downloaded to a buffer area of the process controller for use. The recipe selection may be subject to verification prior to loading to reduce the likelihood of loading the incorrect recipe.

After the recipe is loaded the relationship between respective tasks and the operating parameters for the affected tasks are defined in the process controller. The recipe may then be executed by the process controller. The recipe may be executed a single time or a plurality of times at the discretion of the operations personnel. Multiple executions of the recipe do not require additional loading of the recipe for each execution.

The relationship between the tasks of a particular recipe may be considered as synchronous or asynchronous. Synchronous tasks are executed in a one to one fashion. That is, for each execution of a task 1, a synchronous task 2 will execute once. Asynchronous tasks are executed in a condition based manner. An asynchronous task 2 may execute as long as the conditions for execution are satisfied. As an example, the recipe may provide that task 2 execute upon the completion of task 1. In this example, task 1 is completed and task 2 begins. When task 2 is completed the controller checks the status of task 1 and if task 1 is completed task 2 will execute again and will continue to execute as long as the status of task 1 remains completed.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of controlling a batch process, said method comprising steps of:
a) providing a first controller adapted to receive inputs and to control outputs based upon a predetermined relationship between inputs and outputs,
b) defining the batch process as a batch recipe comprising a collection of tasks,
c) defining at least one task in terms of subtasks, and subtasks in terms of conditions according to the formulae:
$$Task ( i ) = {{⋃}_{j = 1}}^{{N}_{i}} G ( i , j ) = G ( i , 1 ) ⋃ G ( i , 2 ) ⋃ G ( i , 3 ) … ⋃ G ( i , {N}_{i} )$$
$$G ( i , j ) = {{⋂}^{{M}_{ij}}}_{k = 1} C ( i , j , k ) = C ( i , j , 1 ) ⋂ C ( i , j , 2 ) ⋂ C ( i , j , 3 ) … ⋂ C ( i , j , {M}_{ij} )$$
wherein, “∩” represents an “AND” relationship and “∪” represents an “OR” relationship,
d) associating at least one condition with an input of the controller,
e) altering a value of at least one output associated with the at least one task when all of the C(i,j,k) conditions of at least one G(i,j) subtask are satisfied.

2. The method according to claim 1 further comprising the step of:
storing the batch recipe in a memory portion of the first controller.

3. The method according to claim 1 further comprising the step of:
providing an operator interface to the first controller.

4. The method according to claim 3 wherein the step of providing an operator interface to the first controller comprises providing an interface adapted to enable the operator to alter the definition of the at least one task.

5. The method according to claim 4 further comprising the step of:
an operator altering the definition of the at least one task.

6. The method according to claim 5 wherein the step of providing an operator interface to the first controller comprises providing an interface adapted to enable the operator to view a configuration of the batch recipe.

7. The method according to claim 6 further comprising the steps of:
a) displaying the configuration of the batch recipe, and
b) altering the displayed batch recipe configuration according to alterations in the definition of the at least one task.

8. The method according to claim 1 further comprising the step of:
utilizing the satisfaction of the at least one task as a subtask in the definition of at least a second task.

9. The method according to claim 1 wherein the step of defining at least one task in terms of subtasks comprises defining a plurality of tasks in terms of subtasks in terms of the formulae:
$$Task ( i ) = {{⋃}_{j = 1}}^{{N}_{i}} G ( i , j ) = G ( i , 1 ) ⋃ G ( i , 2 ) ⋃ G ( i , 3 ) … ⋃ G ( i , {N}_{i} )$$
$$G ( i , j ) = {{⋂}^{{M}_{ij}}}_{k = 1} C ( i , j , k ) = C ( i , j , 1 ) ⋂ C ( i , j , 2 ) ⋂ C ( i , j , 3 ) … ⋂ C ( i , j , {M}_{ij} )$$
wherein, “∩” represents an “AND” relationship and “∪” represents an “OR” relationship.

10. The method according to claim 1 wherein the step of providing a first controller adapted to receive inputs and to control outputs based upon a predetermined relationship between inputs and outputs comprises a first controller as part of a network of processors.

11. A method of controlling a batch process apparatus, the method comprising steps of:
a) defining a batch process as a batch control recipe comprised of tasks,
b) defining at least one task in terms of the intersection of a plurality of subtasks,
c) defining at least one subtask in terms of a union of a plurality of conditions,
d) providing a controller having discrete input and output values associated with the batch process apparatus,
e) associating at least one condition with an input or output value of the controller,
f) associating at least one task with an output value of the controller,
g) altering the value of at least one output value of the controller according to a change in the status of the at least one task.

12. The method according to claim 11 further comprising the step of:
storing the batch recipe in a memory portion of the first controller.

13. The method according to claim 11 further comprising the step of:
providing an operator interface to the first controller.

14. The method according to claim 13 wherein the step of providing an operator interface to the first controller comprises providing an interface adapted to enable the operator to alter the definition of the at least one task.

15. The method according to claim 14 further comprising the step of:
an operator altering the definition of the at least one task.

16. The method according to claim 15 wherein the step of providing an operator interface to the first controller comprises providing an interface adapted to enable the operator to view a configuration of the batch recipe.

17. The method according to claim 16 further comprising the steps of:
a) displaying the configuration of the batch recipe, and
b) altering the displayed batch recipe configuration according to alterations in the definition of the at least one task.

18. The method according to claim 11 further comprising the step of:
utilizing the satisfaction of the at least one task as a subtask in the definition of at least a second task.

19. The method according to claim 11 wherein the step of defining at least one task in terms of subtasks comprises defining a plurality of tasks in terms of subtasks in terms of the formulae:
$$Task ( i ) = {{⋃}_{j = 1}}^{{N}_{i}} G ( i , j ) = G ( i , 1 ) ⋃ G ( i , 2 ) ⋃ G ( i , 3 ) … ⋃ G ( i , {N}_{i} )$$
$$G ( i , j ) = {{⋂}^{{M}_{ij}}}_{k = 1} C ( i , j , k ) = C ( i , j , 1 ) ⋂ C ( i , j , 2 ) ⋂ C ( i , j , 3 ) … ⋂ C ( i , j , {M}_{ij} )$$
wherein, “∩” represents an “AND” relationship and “∪” represents an “OR” relationship.

20. The method according to claim 11 wherein the step of providing a first controller adapted to receive inputs and to control outputs based upon a predetermined relationship between inputs and outputs comprises a first controller as part of a network of processors.
